(19) United States
(12) Patent Application Publication
(10) Pub. No.: US 2015/0138256 A1
(43) Pub. Date: May 21, 2015

(54) ELECTROPHORETIC DISPLAY APPARATUS AND DRIVE METHOD THEREOF

(71) Applicant: MITSUBISHI PENCIL COMPANY, LIMITED, Tokyo (JP)

(72) Inventor: Shinichi Yamada, Yokohama-shi (JP)

(73) Assignee: MITSUBISHI PENCIL COMPANY, LIMITED, Tokyo (JP)

(21) Appl. No.: 14/396,901

(22) PCT Filed: Apr. 22, 2013
(86) PCT No.: PCT/JP2013/061793

§ 371 Date: Oct. 24, 2014

(30) Foreign Application Priority Data
Apr. 27, 2012 (JP) 2012-103311

(51) Int. Cl. G09G 3/34; G09G 3/20

(52) U.S. Cl. CPC G09G 3/3446; G09G 3/2003; G09G 2310/068; G09G 2320/0666; G09G 2320/0271
USPC 345/691; 345/107

(57) ABSTRACT

An electrophoretic display apparatus is provided that applies to a target pixel, a first voltage pulse a number of times determined according to target gradation of the target pixel to cause the target pixel to transition to a first display state, applies, when the target gradation is in a direction opposite to a direction of the gradation change by the first voltage pulse seen from the first display state, a second voltage pulse which has a polarity opposite to that of the first voltage pulse, and applies, when the target gradation is in the same direction as the direction of the gradation change by the first voltage pulse seen from the first display state, a third voltage pulse which has the same polarity as that of the first voltage pulse.

### TECHNICAL FIELD

The present invention relates to an electrophoretic display apparatus and a drive method thereof that reversibly change a visibility situation by action of an electric field or the like.

### BACKGROUND ART

Conventionally, as methods for controlling gradation of an electrophoretic display apparatus, various methods are proposed such as a method that applies a voltage between electrodes of a target pixel while controlling the length of a drive pulse (e.g., see Patent Literature 1) and a method that performs gradation display by controlling only the number of times a drive pulse is applied between electrodes of a target pixel without changing the pulse length (e.g., see Patent Literature 2). According to the drive method described in Patent Literature 1, a reset voltage is written to each pixel electrode during a reset period Tr and then an applied voltage is applied to each pixel electrode only for a period corresponding to a gradation value indicated by image data for a write period. After this, a common electrode voltage is written to each pixel electrode, and charge stored in a pixel capacitor is discharged so that an electric field acts on a distribution system. After this, a display image is retained. On the other hand, according to the drive method described in Patent Literature 2, in a structure in which an electrophoresis layer containing a plurality of negatively charged first particles having relatively large mobility and a plurality of positively charged second particles having relatively small mobility is sandwiched between a first electrode and a second electrode arranged opposite to each other, a first voltage at which the first electrode becomes relatively higher potential than the second electrode is applied between the first electrode and the second electrode, then a pulse-like second voltage at which the first electrode becomes relatively lower potential than the second electrode is applied intermittently a plural number of times between the first electrode and the second electrode, and the respective second voltages applied a plural number of times have substantially the same pulse width and substantially the same voltage value, and the number of times the second voltage is applied is set according to the gradation.

### CITATION LIST

### Patent Literature

[Patent Literature 1] Japanese Patent Application Laid-Open No. 2002-116733
[Patent Literature 2] Japanese Patent Application Laid-Open No. 2009-237543

### SUMMARY OF THE INVENTION

### Technical Problem

However, when attempting to realize a linear gradation change within a range from a pure black color display to a pure white color display, the drive method described in aforementioned Patent Literature 1 needs to precisely control the length of an extremely short pulse and it is difficult to express multi-gradation.

In order to realize a multi-gradation display, the drive method described in aforementioned Patent Literature 2 needs to apply pulses at a high speed and multiple times, and satisfying such a requirement requires the driver to have performance of high-speed operation.

The present invention has been implemented in view of the above-described problems and it is an object of the present invention to provide an electrophoretic display apparatus and a drive method thereof capable of realizing multi-gradation without increasing performance required for a switching device or a driver that controls the length of a pulse applied to a pixel electrode or application timing, and displaying images of high quality.

### Solution to Problem

An electrophoretic display apparatus of the present invention includes a pair of substrates, at least one of which has a light transmitting property, a plurality of pixel electrodes formed on a substrate surface of one of the pair of substrates, a common electrode formed on a substrate surface of the other of the pair of substrates facing the plurality of pixel electrodes, a liquid-like body composed of at least two types of charged particles having different moving speeds dispersed and sealed in a space formed between the pair of substrates, and a drive circuit that generates a voltage pulse for producing a potential difference that causes the charged particles to move between the pixel electrodes and the common electrode and generates a selection signal that selects a target pixel to which the voltage pulse is to be applied, in which the drive circuit applies to a target pixel, a first voltage pulse a number of times determined according to target gradation of the target pixel to cause the target pixel to transition to a first display state, applies, when the target gradation is in a direction opposite to a direction of the gradation change by the first voltage pulse seen from the first display state, a second voltage pulse which has a polarity opposite to that of the first voltage pulse and has a smaller amount of gradation change per application than that of the first voltage pulse a number of times corresponding to a gradation distance to the target gradation, and applies, when the target gradation is in the same direction as the direction of the gradation change by the first voltage pulse seen from the first display state, a third voltage pulse which has the same polarity as that of the first voltage pulse and has a smaller amount of gradation change per application than that of the first voltage pulse a number of times corresponding to the gradation distance to the target gradation.

In this configuration, since gradation control is performed by combining the first voltage pulse, the second voltage pulse which has a polarity opposite to that of the first voltage pulse and has a smaller amount of gradation change per application than that of the first voltage pulse, and the third voltage pulse which has a polarity identical to that of the first voltage pulse and has a smaller amount of gradation change per application than that of the first voltage pulse, it is not necessary to precisely control the length of an extremely short pulse or apply pulses at a high speed and multiple times, and it is possible to realize multi-gradation without increasing performance required for a switching device or driver that controls the length of a pulse applied to the pixel electrode or application timing thereof.

In the above-described electrophoretic display apparatus, the drive circuit generates voltage pulses having a shorter pixel selection time than that of the first voltage pulse as the second and third voltage pulses. In this way, the first voltage pulse is combined with a voltage pulse which has a shorter pixel selection time than that of the first voltage pulse to achieve gradual approximation to target gradation, and it is therefore possible to relax the performance required for the switching device or driver compared to cases where target gradation is reached by precisely controlling the lengths of extremely short pulses.

In the above-described electrophoretic display apparatus, voltage pulses having the same pixel selection time as that of the first voltage pulse are generated as the second and third voltage pulses, and a repetition cycle when the second and/or the third voltage pulse are/is applied a plural number of times is longer than a repetition cycle of the first voltage pulse. Thus, since voltage pulses having the same pixel selection time as that of the first voltage pulse are used as the second and third voltage pulses, this is applicable to cases where it is difficult to realize writing for a minute selection time (e.g., 10 μsec) for reasons related to the type of TFT or the like and the transfer speed of image data of a display image.

In the above-described electrophoretic display apparatus, slowly moving charged particles may be concentrated on electrodes on the substrate side having a light transmitting property. This makes it possible to shorten a time of transition from an initial state to a desired gradation display.

In the above-described electrophoretic display apparatus, a shaking pulse whose polarity of voltage is alternately inverted may be applied between the pixel electrode of each pixel and the common electrode for all pixels in a control target area or all pixels in a predetermined area. Particles that have become a large lump due to having been left for a long time, will be disentangled by the application of the shaking pulse, and subsequently applied writing pulses will allow the charged particles to move more easily.

### Technical Advantage of the Invention

According to the present invention, it is possible to realize multi-gradation and display images of high quality without increasing the performance required for a switching device or driver that controls the length of a pulse applied to the pixel electrode or application timing thereof.

### BRIEF DESCRIPTION OF DRAWINGS

FIG. 1 is an overall configuration diagram of an electrophoretic display apparatus according to the present embodiment;

FIG. 2 is a circuit diagram illustrating an electrical configuration of pixels in the above-described electrophoretic display apparatus;

FIG. 3 is a partial cross-sectional view of a display section in the above-described electrophoretic display apparatus;

FIG. 4 is a flowchart illustrating gradation control according to a first embodiment;

FIG. 5 is a diagram illustrating transition states of gradation changes according to the first embodiment;

FIG. 6 is a diagram illustrating characteristics of a change in a reflection factor with a black reference and a white reference;

FIG. 7 is a diagram illustrating combinations of voltage pulses that realize the gradation changes shown in FIG. 5;

FIG. 8 is a flowchart illustrating gradation control according to a second embodiment;

FIG. 9 is a diagram illustrating transition states of gradation changes according to the second embodiment;

FIG. 10 is a diagram illustrating combinations of voltage pulses that realize the gradation changes shown in FIG. 9; and

FIG. 11 is a diagram illustrating a voltage change between electrodes when a standard selection pulse is repeatedly applied in scanning cycle T1 and scanning cycle T2.

### DESCRIPTION OF EMBODIMENTS

Hereinafter, embodiments of the present invention will be described in detail with reference to the accompanying drawings.

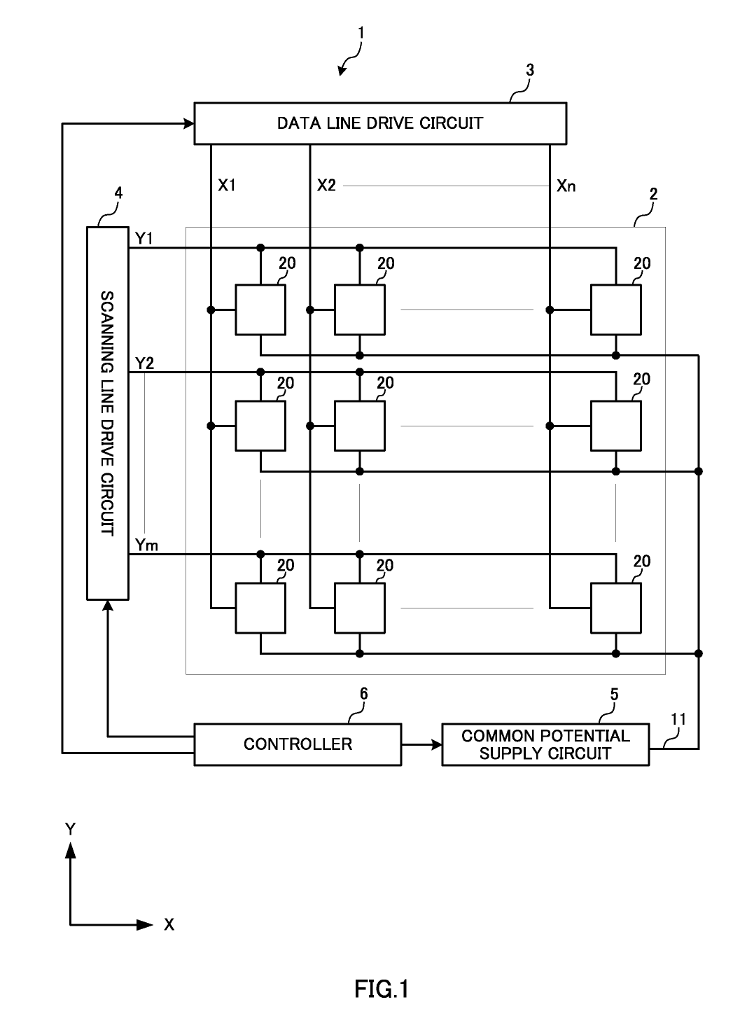

FIG. 1 is an overall configuration diagram of an electrophoretic display apparatus according to a first embodiment of the present invention. This electrophoretic display apparatus 1 is configured by including a display section 2 that has pixels arranged in a matrix form, a data line drive circuit 3 that supplies an image signal to the display section 2, a scanning line drive circuit 4 that supplies a scanning signal to the display section 2, a common potential supply circuit 5 that gives a common potential to each pixel of the display section 2, and a controller 6 that controls operation of the entire apparatus. Of these components, the data line drive circuit 3, scanning line drive circuit 4, common potential supply circuit 5 and controller 6 constitute a drive circuit.

In the display section 2, n data lines X1 to Xn extend from the data line drive circuit in parallel with the column direction (Y direction) and m scanning lines Y1 to Ym extend from the scanning line drive circuit 4 in parallel with the row direction (X direction) crossing the data lines. In the display section 2, pixels 20 are formed at intersections at which the data lines (X1, X2, . . . Xn) and the scanning lines (Y1, Y2, . . . Ym) intersect with each other. In this way, a plurality of pixels 20 are arranged in the form of a matrix of n rows and m columns in the display section 2.

The data line drive circuit 3 supplies an image signal to each data line (X1, X2, . . . Xn) based on a timing signal supplied from the controller 6. The image signal takes a potential of high potential VH (e.g., 30 V) or low potential VL (e.g., 0 V).

The scanning line drive circuit 4 sequentially supplies scanning signals having a fixed pulse width to the respective scanning lines (Y1, Y2, . . . Ym) based on a timing signal supplied from the controller 6. Scanning signals are supplied to the pixels 20 which are drive targets in this way. Since a pixel which becomes a target of gradation control is selected by a scanning signal, the scanning signal can also be called a “selection signal.”

A common potential Vcom is applied to each pixel 20 making up the display section 2 from the common potential supply circuit 5 via a common potential line 11. The common potential Vcom is either a high potential VH (e.g., 40 V) or a low potential VL (e.g., 0 V).

The controller 6 controls each circuit by supplying timing signals such as a clock signal, start pulse to the data line drive circuit 3, scanning line drive circuit 4 and common potential supply circuit 5. The controller 6 supplies gradation data of a target pixel to the data line drive circuit 3 or common potential supply circuit 5. The data line drive circuit 3 or common potential supply circuit 5 determines the number of times a write pulse is applied and a voltage value according to the gradation data, and supplies an image signal or common potential to the target pixel in synchronization with a pixel row selection operation of the scanning line drive circuit 4.

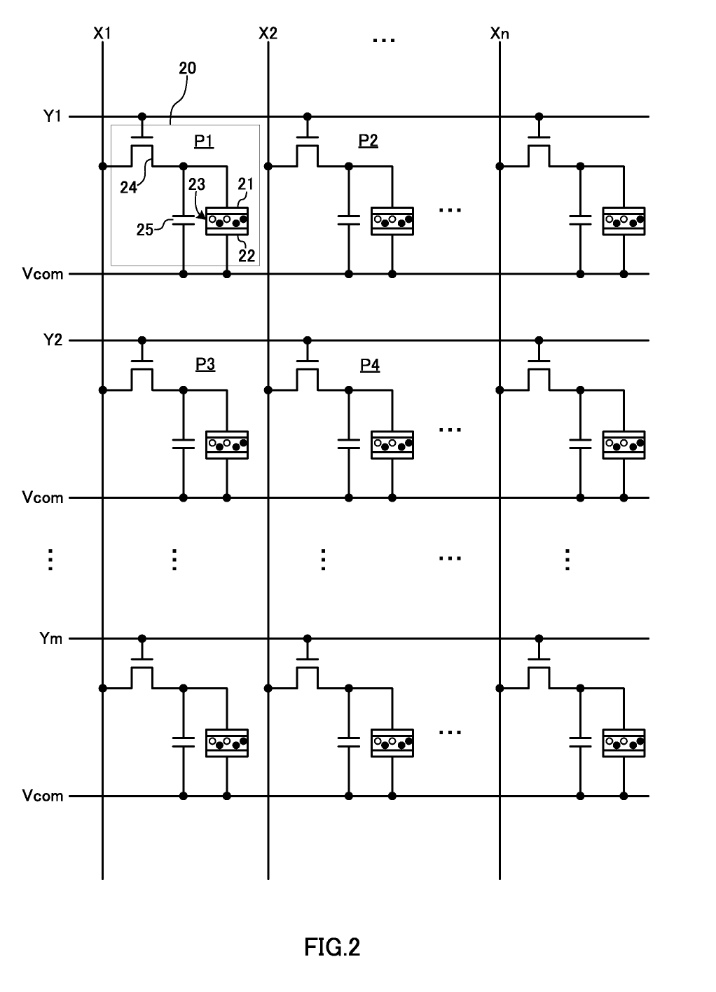

FIG. 2 is an equivalent circuit diagram illustrating an electrical configuration of the pixel 20. Since the respective pixels 20 arranged in the matrix form in the display section 2 have an identical configuration, components making up the pixel 20 will be described, assigned common reference numerals.

The pixel 20 is provided with a pixel electrode 21, a common electrode 22, an electrophoretic element 23, a pixel switching transistor 24, and storage capacitor 25. The pixel switching transistor 24 is made up, for example, of an N-type transistor. The pixel switching transistor 24 is preferably made up of a TFT (Thin Film Transistor). A gate of the pixel switching transistor 24 is electrically connected to a scanning line (Y1, Y2, . . . Ym) of a corresponding row. A source of the pixel switching transistor 24 is electrically connected to a data line (X1, X2, . . . Xn). A drain of the pixel switching transistor 24 is electrically connected to the pixel electrode 21 and storage capacitor 25. The pixel switching transistor 24 outputs an image signal supplied from the data line drive circuit 3 via the data line (X1, X2, . . . Xn) to the pixel electrode 21 and storage capacitor 25 at timing corresponding to a scanning signal pulsively supplied from the scanning line drive circuit via the scanning line (Y1, Y2, . . . Ym) of the corresponding row.

An image signal is supplied to the pixel electrode 21 from the data line drive circuit 3 via the data line (X1, X2, . . . Xn) and the pixel switching transistor 24. The pixel electrode 21 and the common electrode 22 are arranged so as to face each other across the electrophoretic element 23. The common electrode 22 is electrically connected to the common potential line 11 to which the common potential Vcom is supplied.

The electrophoretic element 23 is a liquid containing a plurality of electrophoretic particles and retained between the electrodes by means of a sealer (not shown) so as not to be leaked.

The storage capacitor 25 is made up of a pair of electrodes arranged so as to face each other across a dielectric film, one electrode is electrically connected to the pixel electrode 21 and pixel switching transistor 24 and the other electrode is electrically connected to the common potential line 11. The storage capacitor 25 allows an image signal to be maintained for a predetermined period of time.

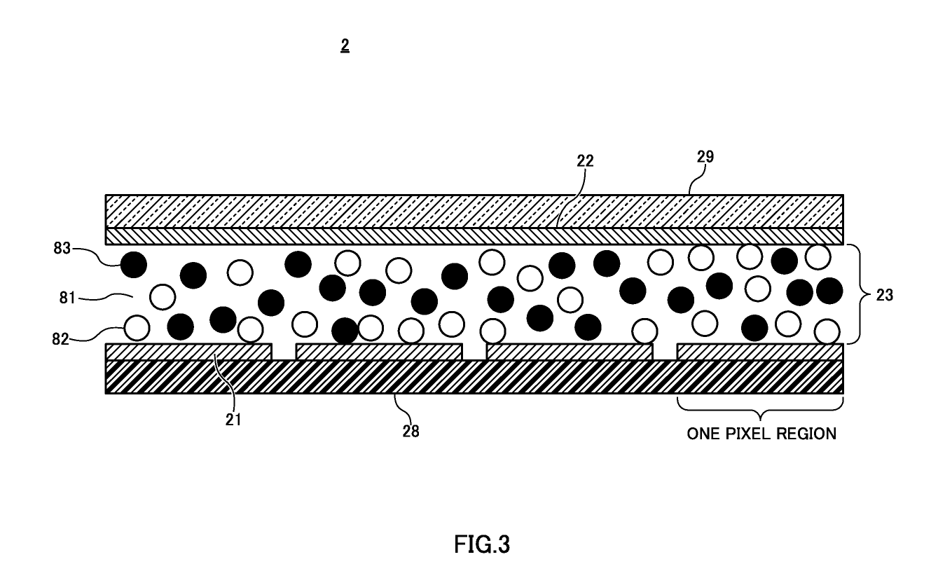

Next, a specific configuration of the display section 2 of the electrophoretic display apparatus 1 will be described based on FIG. 3. FIG. 3 is a partial cross-sectional view of the display section 2 in the electrophoretic display apparatus 1. The display section 2 is configured of an element substrate 28 and an opposite substrate 29 arranged so as to face each other via a spacer (not shown) and with the electrophoretic element 23 sealed in between the substrates. Description will be given in the present embodiment on the assumption that an image is displayed on the opposite substrate 29 side.

The element substrate 28 is a substrate made of, for example, glass or plastics. A laminated structure is formed on the element substrate 28, in which the pixel switching transistor 24, storage capacitor 25, scanning lines (Y1, Y2, . . . Ym), data lines (X1, X2, . . . Xn), common potential line 11 or the like described above with reference to FIG. 2 (not shown here) are built. The plurality of pixel electrodes 21 are provided in a matrix form on the top layer side of this laminated structure.

The opposite substrate 29 is a substrate having a light transmitting property made of, for example, glass or plastics. The common electrode 22 is formed on a surface of the opposite substrate 29 opposite to the element substrate 28 so as to face the plurality of pixel electrodes 21. The common electrode 22 is formed of a transparent conductive material such as magnesium silver (MgAg), indium tin oxide (ITO), indium zinc oxide (IZO).

The electrophoretic element 23 is an electrophoretic display liquid made up of positively charged black color particles 83, negatively charged white color particles 82 and a dispersion medium 81 that disperses the black color particles 83 and white color particles 82, and is sealed in between the element substrate 28 and the opposite substrate 29. Furthermore, a spacer (not shown) for keeping a gap between the substrates to a predetermined value is provided between the element substrate 28 and the opposite substrate 29, and a sealer (not shown) for sealing the gap is provided on end faces of the substrates.

In FIG. 3, when a voltage is applied between the pixel electrode 21 and the common electrode 22 so that the potential of the common electrode 22 becomes relatively higher, the positively charged black color particles 83 are attracted toward the pixel electrode 21 side by a Coulomb force and the negatively charged white color particles 82 are attracted toward the common electrode 22 side by the Coulomb force. As a result, the white color particles 82 are concentrated on the display surface side (common electrode 22 side) and the display surface of the display section 2 becomes a white color display. On the other hand, when a voltage is applied between the pixel electrode 21 and the common electrode 22 so that the potential of the pixel electrode 21 becomes relatively higher (potential of the common electrode 22 becomes relatively lower), the positively charged black color particles 83 are attracted toward the common electrode 22 side by the Coulomb force and the negatively charged white color particles 82 are attracted toward the pixel electrode 21 side by the Coulomb force. As a result, the black color particles 83 are concentrated on the display surface side (common electrode 22 side) and the display surface of the display section 2 becomes a black color display.

Note that the display surface of the display section 2 can be changed to a red color display, green color display, blue color display or the like by changing pigments used for the white color particles 82 and black color particles 83 to pigments of, for example, red color, green color and blue color or the like.

When particles are placed under the same electric field, the moving speeds, for example, of the white particles and black particles differ depending on the size of particles and other factors. The present embodiment will be described on the assumption that the white particles have a higher moving speed than that of the black particles.

Next, a drive method for realizing suitable gradation display in the electrophoretic display apparatus 1 configured as described above will be described. Regarding resolution of a gradation display, for example, a pure black color display (minimum side saturation reflection factor) is associated with a first gradation and a pure white color display (maximum side saturation reflection factor) is associated with a 16th gradation step. Moreover, a pixel to display the first gradation is associated with pixel 1, a pixel to display a second gradation step is associated with pixel 2, and similar association is applied to subsequent gradations, and a pixel to display the 16th gradation is associated with pixel 16.

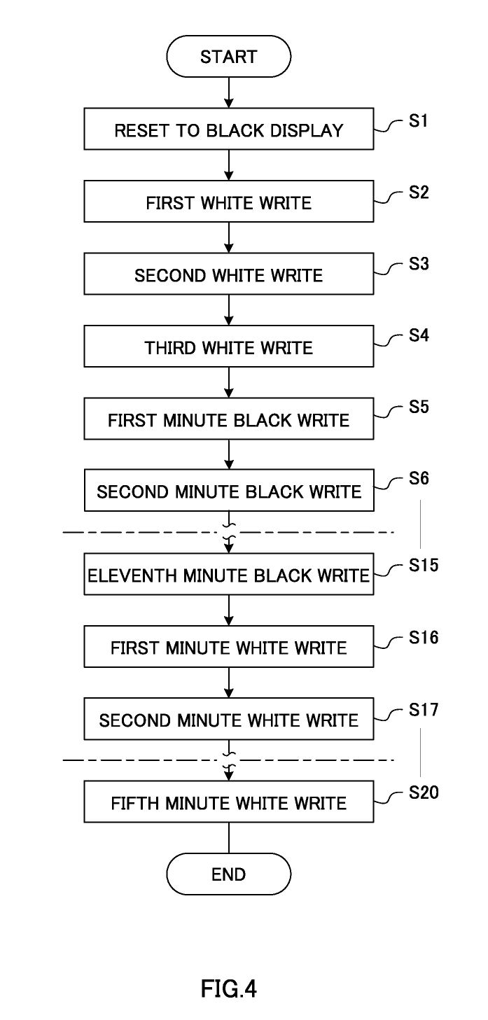

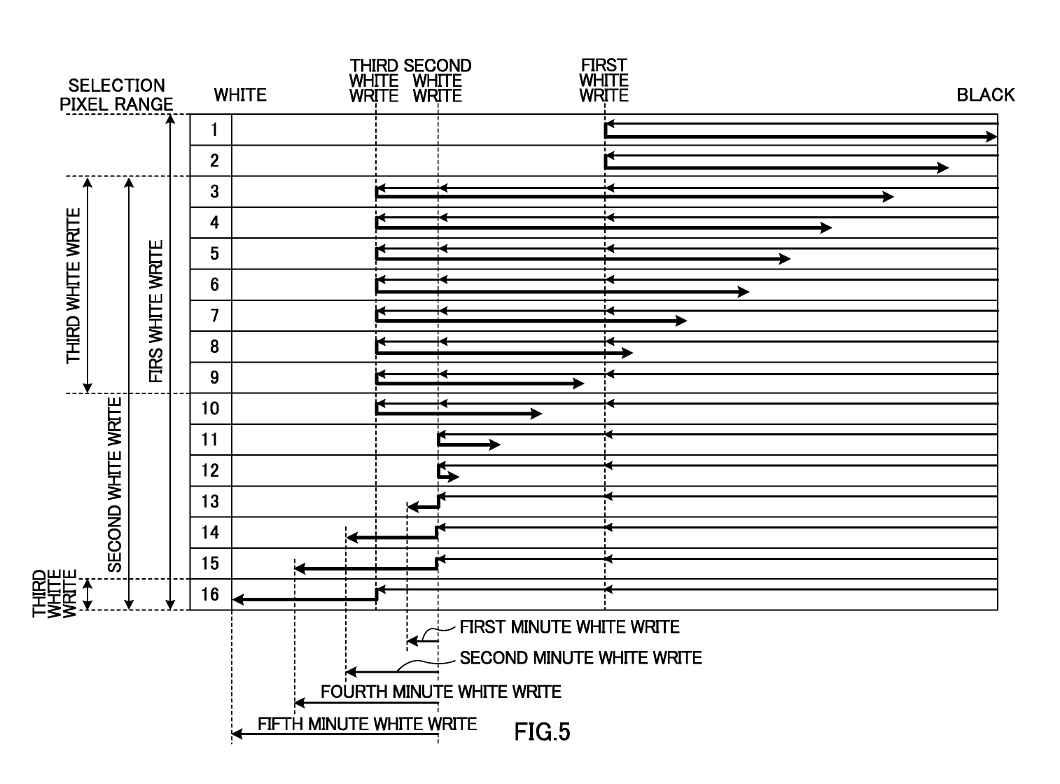

A drive method for realizing a required gradation display for pixel 1 to pixel 16 will be described with reference to FIG. 4 and FIG. 5. FIG. 4 is a flowchart until pixel 1 to pixel 16 are changed to required gradations and FIG. 5 is a gradation transition diagram corresponding to the flowchart shown in FIG. 4. In FIG. 5, numbers 1 to 16 shown at the left end on the vertical axis correspond to pixel numbers and the horizontal axis corresponds to gradation. Pixel 1 to pixel 16 correspond to the pixels 20 shown in FIG. 2.

First, all pixels 1 to 16 are reset to black color display (first gradation: minimum side saturation reflection factor) (step S1). Thus, for all pixels 1 to 16, a low potential VL is applied to the common electrode 22 and a high potential VH is applied to the pixel electrode 21. Immediately after the reset in step S1, all pixels 1 to 16 become black color display (first gradation).

Next, white write is performed once on all pixels 1 to 16 (step S2). In the white write, the high potential VH is applied to the common electrode 22, the low potential VL is applied to the pixel electrode 21, and a standard selection pulse which becomes a scanning signal is applied to the gate of the pixel switching transistor 24 of the write target pixel 20. A first voltage pulse to be applied between the pixel electrodes is generated according to the potential applied to the common electrode 22, the potential applied to the pixel electrode 21 and the standard selection pulse applied to the gate of the pixel switching transistor 24. The pulse length of the standard selection pulse is, for example, 40 μsec and a selection time which is a white write time for pixel 20 is 40 μsec. The scanning line drive circuit 4 sequentially applies standard selection pulses to pixel 1 to pixel 16, and scans all pixels 1 to 16 once. Through the white write by the standard selection pulses, gradation displays of all pixels 1 to 16 change to “first white write” shown in FIG. 5. As a result, pixel 1 and pixel 2 reach a first display state as shown in FIG. 5.

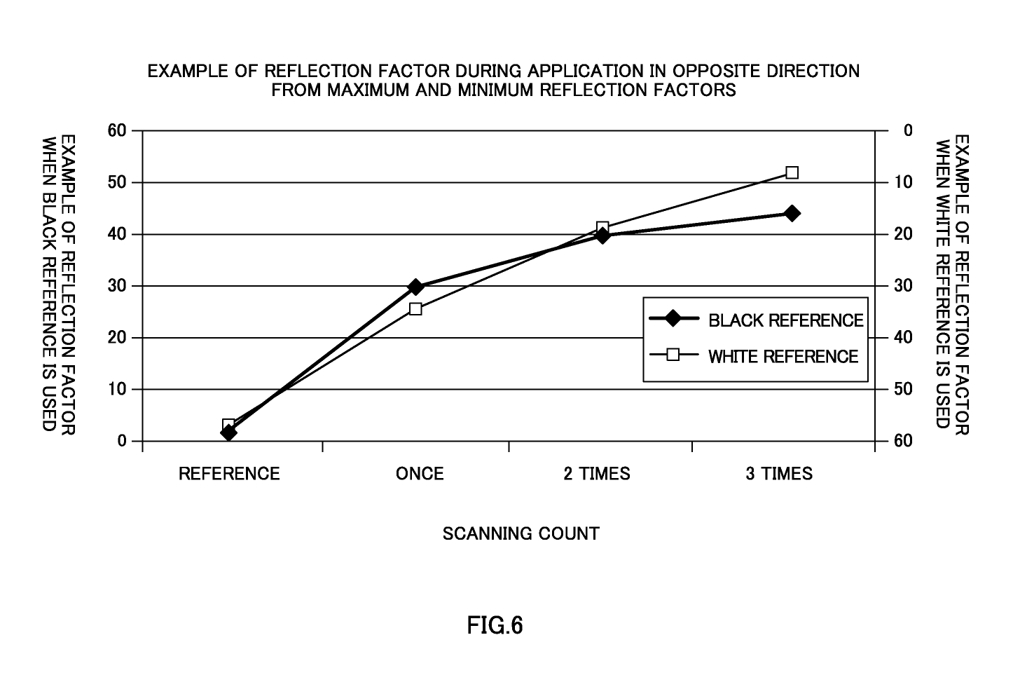

Here, the meaning of resetting all pixels 1 to 16 to a black color display before performing white write will be described. FIG. 6 illustrates a change characteristic (black reference) when the pixel 20 is changed in gradation from a state of black color display to a white color display by repeating scanning of white write and a change characteristic (white reference) when the pixel 20 is changed in gradation from a state of a white color display to a black color display by repeating scanning of black write. It is observed that the change characteristic using the black reference has a larger difference in the rate of change between the first scanning and the second scanning than that of the change characteristic using the white reference. This gives an understanding that the black reference has a wider range of selection of a reflection factor by a combination of scanning counts than the white reference. Thus, starting a gradation change with the black reference (black color display) provides a wider selection range of the reflection factor and it is thereby possible to achieve required gradation more easily.

A shaking pulse may be applied to all pixels 1 to 16 before performing white write once in step S2. The drive circuit made up of the data line drive circuit 3, scanning line drive circuit 4, common potential supply circuit 5 and controller 6 or the like applies a shaking pulse which causes the voltage polarity to be inverted alternately within a short time between the pixel electrode 21 and the common electrode 22 of each pixel 20 for all pixels in the control target area or pixels in a predetermined area.

Next, a second white write is performed on pixel 3 to pixel 16 except pixel 1 and pixel 2 (step S3). The scanning line drive circuit 4 sequentially applies a standard selection pulse to pixel 3 to pixel 16 and scans all pixels 3 to 16 once. This second white write causes the gradation display of pixels 3 to 16 to change to “second white write” shown in FIG. 5. The amount of gradation change by the second white write is smaller than that of the first white write because as shown in FIG. 6, the variation in the second scanning is smaller than that in the first scanning using the black reference. The second white write causes pixel 11 to pixel 15 to reach the first display state.

Next, a third white write is performed on pixel 3 to pixel 10 and pixel 16 (step S4). The scanning line drive circuit 4 sequentially applies a standard selection pulse to pixel 3 to pixel 10 and pixel 16 and scans all pixels 3 to 10 and 16 once. This third white write causes the gradation display of pixels 3 to 10 and 16 to change to “third white write” shown in FIG. 5. The amount of gradation change by the second white write is smaller than that of the second white write. The third white write causes pixel 3 to pixel 10 and pixel 16 to reach the first display state.

Next, a minute black write is performed on pixel 1 to pixel 12 using a second voltage pulse having a polarity opposite to that of the first voltage pulse to wrap around the gradation display of pixel 1 to pixel 12 to the black color display side. Here, in a minute black write, the overall scanning time is kept as is, and a black write is performed by shortening the selection time of write target pixel 20 and equivalently reducing the applied voltage to the pixel electrode 22. Equivalently reducing the applied voltage is intended to facilitate subtle gradation control. In the present embodiment, the minute black write is achieved by applying a minute selection pulse having a selection time smaller than the standard selection time (40 μsec) by the standard selection pulse (e.g., 10 μsec). Furthermore, since this is a black write, the low potential VL is applied to the common electrode 22 and the high potential VH is applied to the pixel electrode 21, and the minute selection pulse is applied to the gate of the pixel switching transistor 24 of the write target pixel 20. A second voltage pulse is generated according to a minute selection pulse for a minute black write, the applied potential of the common electrode 22 and the applied potential of the pixel electrode 21.

A first minute black write is performed on pixel 1 to pixel 12 which are pixels to be wrapped around to the black color display side (step S5). Scanning line drive circuit 4 sequentially applies a minute selection pulse to pixel 1 to pixel 12, and scans pixel 1 to pixel 12 once. For example, pixel 12 shown in FIG. 5 indicates a gradation position at which the gradation position of the second white write is wrapped around to the black color display side by the first minute black write.

Hereinafter, similarly, second to eleventh minute black writes are performed on pixel 2 to pixel 12 by decrementing the final pixel number by 1 every time the step number is incremented through step S6 to step S15. The gradation display of pixel 1 to pixel 12 shown in FIG. 5 is gradation at a time when the minute black write is aborted.

Through the above-described gradation control, gradation display of pixel 1 to pixel 12 has been successfully displayed from the first gradation to 12th gradation.

Next, a minute white write is performed on pixel 13 to pixel 16 using a third voltage pulse which has the same polarity as that of the first voltage pulse and has a shorter selection time, and the gradation display of pixel 13 to pixel 16 is added to the white color display side. Here, in the minute white write, as in the case of the minute black write, the overall scanning time is kept as is, the selection time of the write target pixel 20 is shortened, and a white write is performed by equivalently reducing the applied voltage to the pixel electrode 22. A third voltage pulse is generated according to a minute selection pulse for the minute white write, the applied potential of the common electrode 22 and the applied potential of the pixel electrode 21.

A first minute white write is performed on pixel 13 to pixel 16 which are pixels to be added to the white color display side (step S16). The scanning line drive circuit 4 sequentially applies a minute selection pulse to pixel 13 to pixel 16 and scans pixel 13 to pixel 16 once. For example, pixel 13 shown in FIG. 5 indicates a gradation position at which a pixel is added from the gradation position of the second white write to the white color display side by the first minute white write.

Hereinafter, similarly, second to fifth minute white writes are performed on pixel 13 to pixel 16 by incrementing the start pixel number by 1 every time the step number is incremented through step S17 to step S20. The gradation display of pixel 13 to pixel 16 shown in FIG. 5 is gradation when the minute white write is aborted at a time when the target gradation is reached.

Through the above-described gradation control, gradation display of pixel 13 to pixel 16 has been successfully displayed from the 13th gradation to the 16th gradation.

That is, this means that gradation display from pixel 1 to pixel 16 has been successfully performed from the first gradation to 16th gradation by combining the white write according to the standard selection time, the minute black write according to the minute selection time and the minute white write, and selecting the pixel to be wrapped around to the black color display side and the pixel to be added to the white color display side.

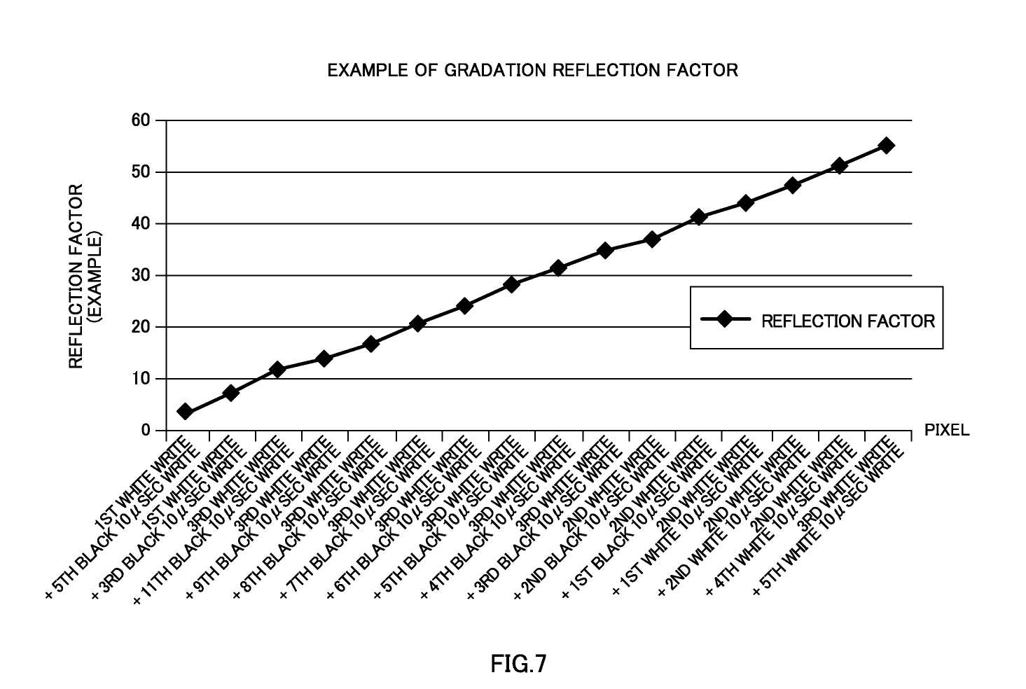

FIG. 7 illustrates a combination of a white write count, minute black write count and minute white write count when pixel 1 to pixel 16 are displayed in the first gradation to 16th gradation. In FIG. 7, pixel 1 corresponds to the left end and pixel 16 corresponds to the right end on the horizontal axis.

A case has been described so far where gradation display which linearly changes from the first gradation to the 16th gradation is performed on 16 pixels from pixel 1 to pixel 16. According to the present embodiment, it is possible to perform a desired gradation display at a desired pixel in accordance with any given display image and realize a gradation display that reproduces the display image with high accuracy.

As described above, according to the first embodiment, it is possible to realize multi-gradation and display images of high quality without increasing the performance required for a switching device or driver for controlling the length of a pulse applied to the pixel electrode or application timing thereof.

Next, an electrophoretic display apparatus according to a second embodiment of the present invention will be described.

A configuration and basic operation of the electrophoretic display apparatus according to the second embodiment are the same as those of the electrophoretic display apparatus according to the aforementioned first embodiment. Here, a drive method for implementing a required gradation display of the electrophoretic display apparatus according to the second embodiment will be described.

In the first embodiment, the required gradation display is achieved by performing a white write according to a standard selection time (40 μsec) and then performing a black or white write according to a minute selection time (10 μsec). However, for reasons related to the type of TFTs making up the pixel switching transistor 24 or the transfer speed of image data of a display image, it is difficult to realize a write according to a minute selection time (10 μsec) and there may be cases where the standard selection time (40 μsec) cannot help but be set to a minimum selection time.

The second embodiment is an example of case where a gradation display equivalent to that of the first embodiment is performed without making the pixel selection time (corresponding to a gate ON period of the pixel switching transistor 24) shorter than the standard selection time (40 μsec).

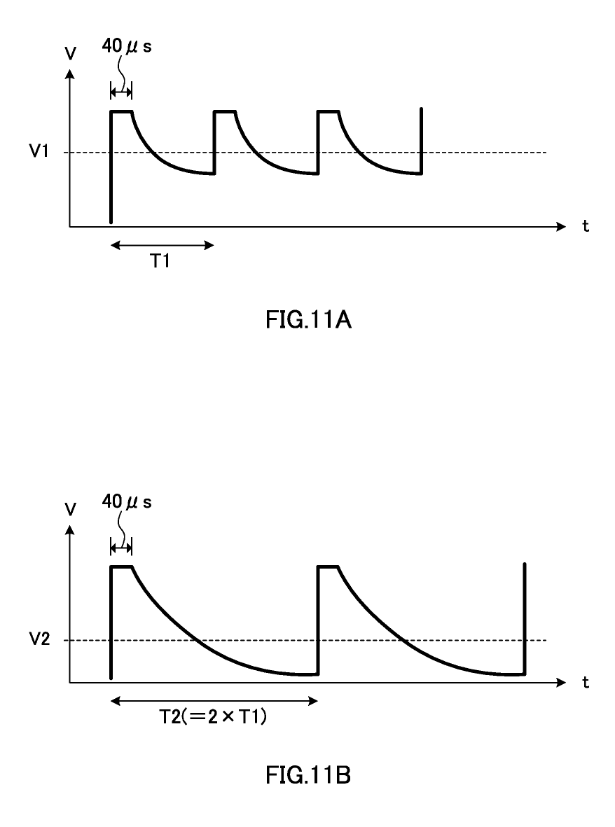

Thus, the second embodiment applies a standard selection time (40 μsec) as a pixel selection time, sets a scanning cycle (repetition cycle of a voltage pulse) to twice the cycle in the first embodiment to thereby equivalently reduce the voltage down to a level equivalent to a voltage during a write according to a minute selection time (10 μsec) and realizes a subtle gradation display. FIG. 11A illustrates a voltage between electrodes when a standard selection pulse having a pulse width of a standard selection time (40 μsec) is repeatedly applied to the gate of the pixel switching transistor 24 of the pixel 20 in a scanning cycle T1. In the scanning cycle T1, a next standard selection pulse is applied before the voltage decreases sufficiently, and therefore an average voltage level becomes V1. FIG. 11B illustrates a voltage between electrodes when a standard selection pulse having a pulse width of a standard selection time (40 μsec) is repeatedly applied to the gate of the pixel switching transistor 24 of the pixel 20 in twice the scanning cycle T1, that is, cycle T2 (2×T1). In the scanning cycle 2·T1 which is a double cycle, a next standard selection pulse is applied after the voltage decreases sufficiently, an average voltage level V2 is lower than V1 shown in FIG. 11A. The present embodiment takes advantage of the fact that when pixels are driven in the scanning cycle T2 which is twice the scanning cycle T1, the voltage between the electrodes decreases compared to when pixels are driven in the scanning cycle T1.

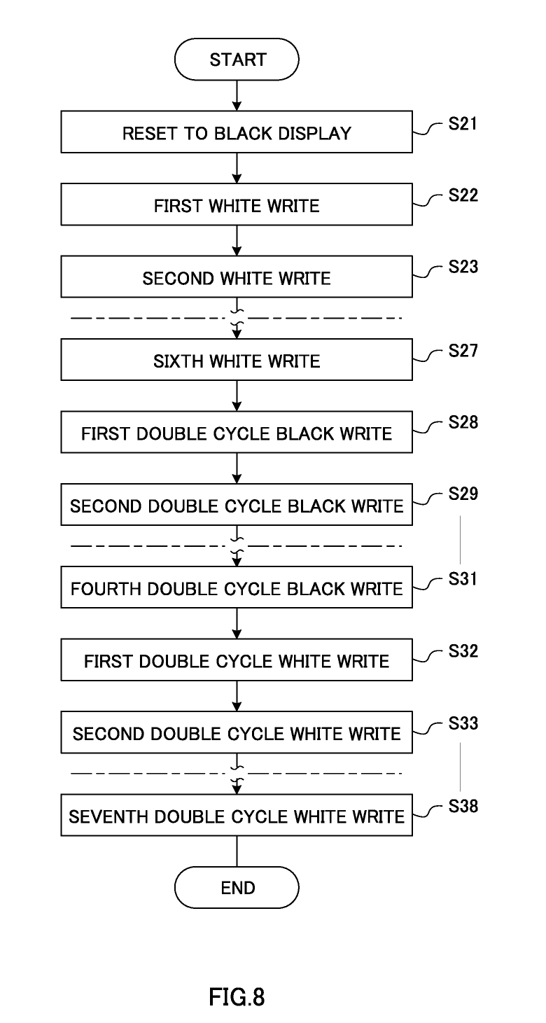

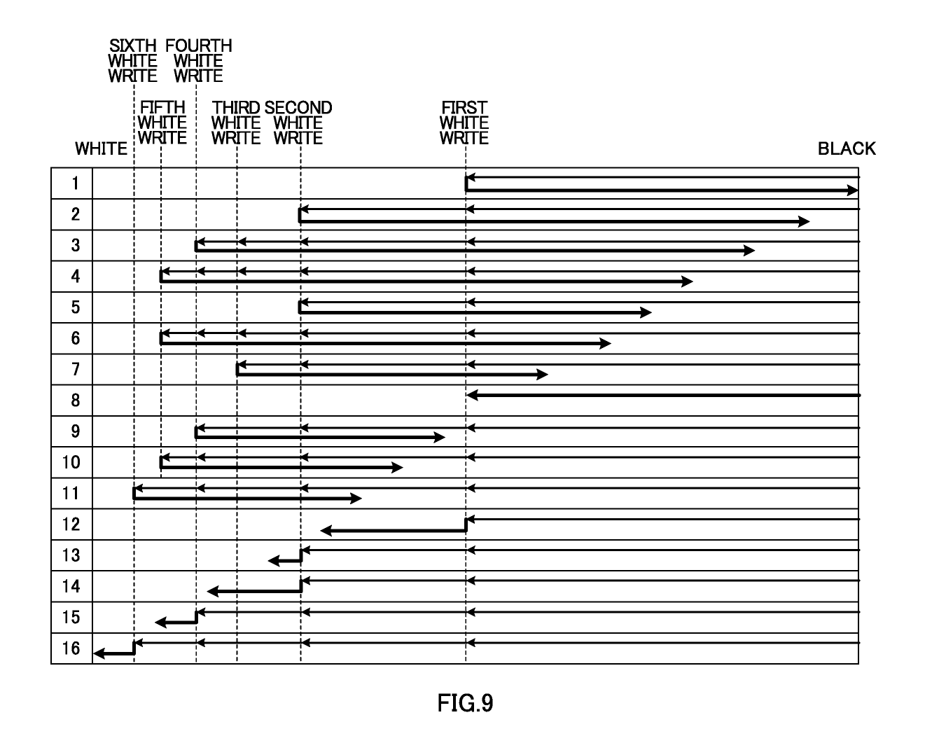

A drive method for realizing a required gradation display for pixel 1 to pixel 16 will be described with reference to FIG. 8 and FIG. 9. FIG. 8 is a flowchart until pixel 1 to pixel 16 are changed to required gradation and FIG. 9 is a gradation transition diagram corresponding to the flowchart shown in FIG. 8. In FIG. 8, numbers 1 to 16 shown at the left end in a vertical direction (vertical axis) correspond to pixel numbers and the horizontal axis corresponds to gradation. Pixel 1 to pixel 16 correspond to the pixels 20 shown in FIG. 2.

First, all pixels 1 to 16 are reset to black color display (first gradation) (step S21). For this reason, a low potential VL is applied to the common electrode 22 for all pixels 1 to 16 and a high potential VH is applied to the pixel electrode 21. Immediately after the reset in step S21, all pixels 1 to 16 become black color display (first gradation).

Furthermore, in step S22, before performing a white write once, a shaking pulse may also be applied to all pixels 1 to 16. The drive circuit made up of the data line drive circuit 3, scanning line drive circuit 4, common potential supply circuit 5 and controller 6 or the like applies a shaking pulse which causes the voltage polarity to be inverted alternately within a short time between the pixel electrode 21 and the common electrode 22 of each pixel 20 for all pixels in the control target area or pixels in a predetermined area.

Next, a white write is performed once on all pixels 1 to 16 (step S22). The white write is performed by applying a high potential VH to the common electrode 22, applying a low potential VL to the pixel electrode 21 and applying a standard selection pulse which becomes a scanning signal to the gate of the pixel switching transistor 24 of the write target pixel 20. The pulse width of the standard selection pulse is, for example, 40 μsec, and the selection time which is a white write time to the pixel 20 is 40 μsec. A first voltage pulse is generated according to an applied potential of the common electrode 22, an applied potential of the pixel electrode 21 and a standard selection pulse (scanning cycle T1). The scanning line drive circuit 4 sequentially applies a standard selection pulse to pixel 1 to pixel 16 and scans all pixels 1 to 16 once. At this time, the scanning time required to scan the whole screen once is T1. Through the white write by the standard selection pulse, the gradation display of all pixels 1 to 16 changes to “first white write” shown in FIG. 9.

Next, a second white write is performed on pixels except pixel 1, pixel 8 and pixel 12 (step S23). Hereinafter, pixels are selected as shown in FIG. 9 and third to sixth white writes are performed on selected pixels (step S24 to step S27). The scanning cycle in step S22 to step S27 is T1.

Next, for pixels whose gradation display is wrapped around to the black display side, a double cycle black write is performed in scanning cycle T2 which is twice scanning cycle T1. As described above, even when a double cycle black write is performed in scanning cycle T2, the selection time of pixel 20 is 40 μsec using a standard selection pulse. A second voltage pulse is generated according to the standard selection pulse during the double cycle black write, the applied potential of the common electrode 22 and the applied potential of the pixel electrode 21.

Pixels are selected as shown in FIG. 9, the whole screen is scanned in scanning cycle T2, first to fourth double cycle black writes are performed on the selected pixels (step S28 to step S31). During the first to fourth double cycle black writes in scanning cycle T2, since the voltage (V2) between the electrodes for the writes is lower than the voltage (V1) between the electrodes during the black write in scanning cycle T1, a finer gradation display is possible compared to the black write in scanning cycle T1.

Through the above-described gradation control, gradation displays for pixels 1 to 7 and pixels 9 to 11 are completed.

Next, gradation is added to the white display side for pixel 12 to pixel 16. Double cycle white writes are performed on the pixels to be added to the white color display side in scanning cycle T2 which is double scanning cycle T1. The selection time of pixel 20 is 40 μsec which is a standard selection time. A third voltage pulse is generated according to the standard selection pulse during the double cycle white write, the applied potential of the common electrode 22 and the applied potential of the pixel electrode 21.

Pixels are selected as shown in FIG. 9, the whole screen is scanned in scanning cycle T2, and first to seventh double cycle white writes are performed on the selected pixels (step S32 to step S38). During the first to seventh white writes in scanning cycle T2, since the voltage (V2) between the electrodes for the writes is lower than the voltage (V1) between the electrodes during the white write in scanning cycle T1, a finer gradation display is possible compared to the white write in scanning cycle T1.

This means that through the above-described gradation control, gradation for pixels 13 to 16 has been successfully displayed from the 13th gradation to 16th gradation.

That is, this means that by combining the white write according to the standard selection time, the double cycle white write which is double the scanning cycle with the same standard selection time and the double cycle black write which is double the scanning cycle with the same standard selection time and selecting pixels to be wrapped around to the black color display side and pixels to be added to the white color display side, gradation from pixel 1 to pixel 16 has been successfully displayed in the first gradation to the 16th gradation.

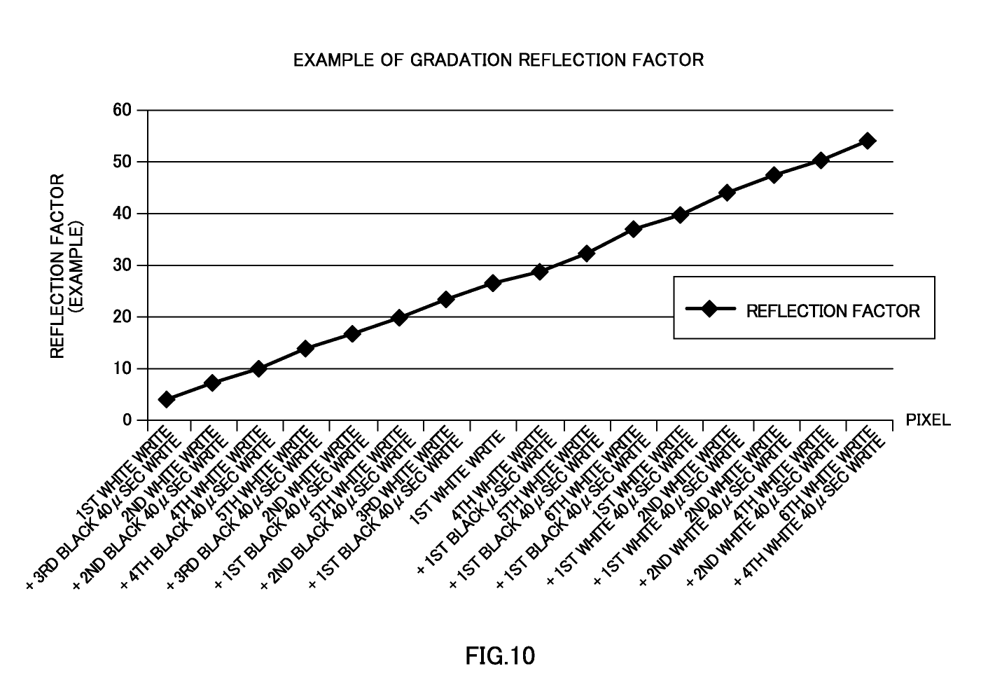

FIG. 10 illustrates combinations of white write count, black write count, double cycle white write count and double cycle black write count when pixel 1 to pixel 16 are displayed in the first gradation to the 16th gradation. In FIG. 10, the left end on the horizontal axis corresponds to pixel 1 and the right end corresponds to pixel 16.

As described above, the second embodiment controls a voltage applied between the electrodes of target pixels by combining scanning cycles with the same standard selection time, and can thereby realize multi-gradation without increasing the performance required for a switching device or driver and display images of high quality. Particularly when it is difficult to realize a write according to a minute selection time (10 μsec) for reasons related to the type of TFTs or the transfer speed of image data of a display image, it is possible to realize multi-gradation using the standard selection time (40 μsec) as a minimum selection time and display images of high quality.

The present invention is not limited to the above-described embodiments, but can be implemented modified in various ways. In the above-described embodiments, the sizes and shapes illustrated in the accompanying drawings are not limited to them, but can be changed as appropriate within a range in which effects of the present invention can be exerted. Other elements can also be implemented modified as appropriate without departing from the scope of the objects of the present invention.

This application is based on the Japanese Patent Application No. 2012-103311, filed on Apr. 27, 2012, entire content of which is expressly incorporated by reference herein.

1. An electrophoretic display apparatus comprising:
a pair of substrates, at least one of which has a light transmitting property;
a plurality of pixel electrodes formed on a substrate surface of one of the pair of substrates;
a common electrode formed on a substrate surface of the other of the pair of substrates facing the plurality of pixel electrodes;
a liquid-like body composed of at least two types of charged particles having different moving speeds dispersed and sealed in a space formed between the pair of substrates; and
a drive circuit that generates a voltage pulse for producing a potential difference that causes the charged particles to move between the pixel electrodes and the common electrode and generates a selection signal that selects a target pixel to which the voltage pulse is to be applied, wherein:
the drive circuit applies to a target pixel, a first voltage pulse a number of times determined according to target gradation of the target pixel to cause the target pixel to transition to a first display state, applies, when the target gradation is in a direction opposite to a direction of the gradation change by the first voltage pulse seen from the first display state, a second voltage pulse which has a polarity opposite to that of the first voltage pulse and has a smaller amount of gradation change per application than that of the first voltage pulse a number of times corresponding to a gradation distance to the target gradation, and applies, when the target gradation is in the same direction as the direction of the gradation change by the first voltage pulse seen from the first display state, a third voltage pulse which has the same polarity as that of the first voltage pulse and has a smaller amount of gradation change per application than that of the first voltage pulse a number of times corresponding to the gradation distance to the target gradation.

2. The electrophoretic display apparatus according to claim 1, wherein the drive circuit generates voltage pulses having a shorter pixel selection time than that of the first voltage pulse as the second and third voltage pulses.

3. The electrophoretic display apparatus according to claim 1, wherein the drive circuit generates voltage pulses having the same pixel selection time as that of the first voltage pulse as the second and third voltage pulses, and a repetition cycle when the second and/or the third voltage pulse(s) is/are applied a plural number of times is longer than a repetition cycle of the first voltage pulse.

4. The electrophoretic display apparatus according to claim 1, wherein the drive circuit causes slowly moving charged particles to be concentrated on electrodes on the substrate side having a light transmitting property by applying a reset pulse to a target pixel before transition to the first display state.

5. The electrophoretic display apparatus according to claim 1, wherein the drive circuit applies a shaking pulse whose polarity of voltage is alternately inverted between the pixel electrode of each pixel and the common electrode for all pixels in a control target area or all pixels in a predetermined area.

6. A method for driving an electrophoretic display apparatus comprising a pair of substrates, at least one of which has a light transmitting property, a plurality of pixel electrodes formed on a substrate surface of one of the pair of substrates, a common electrode formed on a substrate surface of the other of the pair of substrates facing the plurality of pixel electrodes, a liquid-like body composed of at least two types of charged particles having different moving speeds dispersed and sealed in a space formed between the pair of substrates, and a drive circuit that generates a voltage pulse for producing a potential difference that causes the charged particles to move between the pixel electrodes and the common electrode and generates a selection signal that selects a target pixel to which the voltage pulse is to be applied, the method comprising:
applying to a target pixel, a first voltage pulse a number of times determined according to target gradation of the target pixel to cause the target pixel to transition to a first display state;
applying, when the target gradation is in a direction opposite to a direction of the gradation change by the first voltage pulse seen from the first display state, a second voltage pulse which has a polarity opposite to that of the first voltage pulse and has a smaller amount of gradation change per application than that of the first voltage pulse a number of times corresponding to a gradation distance to the target gradation; and
applying, when the target gradation is in the same direction as the direction of the gradation change by the first voltage pulse seen from the first display state, a third voltage pulse which has the same polarity as that of the first voltage pulse and has a smaller amount of gradation change per application than that of the first voltage pulse a number of times corresponding to the gradation distance to the target gradation.

7. The electrophoretic display apparatus according to claim 2, wherein the drive circuit causes slowly moving charged particles to be concentrated on electrodes on the substrate side having a light transmitting property by applying a reset pulse to a target pixel before transition to the first display state.

8. The electrophoretic display apparatus according to claim 3, wherein the drive circuit causes slowly moving charged particles to be concentrated on electrodes on the substrate side having a light transmitting property by applying a reset pulse to a target pixel before transition to the first display state.

9. The electrophoretic display apparatus according to claim 2, wherein the drive circuit applies a shaking pulse whose polarity of voltage is alternately inverted between the pixel electrode of each pixel and the common electrode for all pixels in a control target area or all pixels in a predetermined area.

10. The electrophoretic display apparatus according to claim 3, wherein the drive circuit applies a shaking pulse whose polarity of voltage is alternately inverted between the pixel electrode of each pixel and the common electrode for all pixels in a control target area or all pixels in a predetermined area.
